(19) United States
(12) Patent Application Publication
(10) Pub. No.: US 2002/0172637 A1
(43) Pub. Date: Nov. 21, 2002

(54) Activated carbon with a high adsorption capacity and a low residual phosphoric acid content, a process for its preparation, and applications of it

(75) Inventors: Manuel Chesneau, La Ferte Saint Aubin (FR); Myriam Pilard, Paris (FR); Anne Flasseur, Nohant En Gracay (FR); Gerard Dagois, Asnieres (FR)

Correspondence Address: BROWDY AND NEIMARK, P.L.L.C., 624 NINTH STREET, NW, SUITE 300, WASHINGTON, DC, 20001-5303, US

(73) Assignee: PICA, Levallois Cedex (FR)

(21) Appl. No.: 10/085,126

(22) Filed: Mar. 1, 2002

(30) Foreign Application Priority Data
Mar. 1, 2001 (FR) 0102820

(51) Int. Cl. C01B 31/00; C09C 1/56

(52) U.S. Cl. 423/445 R; 423/460

(57) ABSTRACT

An activated carbon is disclosed having the following characteristics:

CCl₄ number from 120% to 190%,

P₂O₅ content at most equal to 2%,

extraction pH greater than 7,

bulk density from 0.18 g/ml to 0.32 g/ml, and

electrical resistivity less than 1.5 ohm.cm.

### BACKGROUND OF THE INVENTION

1. Field of the Invention

The invention relates to an activated carbon, a process for its preparation and applications of it, in particular to water treatment.

The invention can be understood as an improvement to an existing activated carbon, sold under the trademark “Picabiol®”, for use in the treatment of drinking water. The company Pica has developed a specific water treatment process advantageously employing this product in a biological water purification contactor for the production of drinking water, and an associated control method (see EP-0 377 356 B1 and U.S. Pat. Nos. 5,037,550 and 5,087,354).

The process uses a filter filled with (“Picabiol®” activated carbon type), operating in biological mode: the carbon-containing material acts as support for bacteria which can decompose biodegradable organic matter in the water to be treated. The attachment of the bacteria (with sizes from 0.5 to 2 μm) to the carbon-containing material and their growth thereon are made possible by providing suitable macropores (pore size greater than 500 Å). The presence of micropores (pore size less than 20 Å) and of mesopores (pore size from 20 Å to 500 Å) also allows the filter to operate conventionally by adsorption.

The adsorption of organic and inorganic pollutants present in water by activated carbon is very widely used (see in particular: Porosity in Carbons, J. W. Patrick, 1995, Edward Arnold). These pollutants are classified as follows: detergents, pesticides, herbicides, trace metals, polycyclic aromatic hydrocarbons, organic compounds of low solubility, chlorinated derivatives, colored or odorous entities, humic acids, and the like.

“Picabiol®” activated carbon is manufactured industrially by a conventional chemical activation process. A mixture of wood granules and phosphoric acid is heated in a rotary furnace at approximately 400° C. to 500° C., washed and dried. This starting material and its activation produce the macropores required for the biological activity, and the smaller pores required for adsorption, and in many cases this material is entirely satisfactory. However, it has a characteristic which is generally underestimated, namely a not insignificant residual content of P₂O₅ (or H₃PO₄ in the hydrated form), from 3% to 12% by weight, which can be a handicap in some cases.

The specifications of the “Picabiol®” product are summarized in the table below, the residual P₂O₅, the extraction pH, the electrical resistivity and the BET surface area being measured by in-house methods described below:

Residual P₂O₅ (in %):

The activated carbon is subjected to aqueous extraction by a conventional Soxhlet system heated at reflux for 12 hours (5 g of activated carbon per 300 ml of water). The aqueous extraction and rinsing liquors are recovered and then made up to 500 ml with demineralized water.

The starting point for the quantitative determination of the P₂O₅ is the preparation of a KH₂PO₄ mother solution of known titer; it is used to prepare the standard solutions, by different dilutions. These standard solutions are brought into contact with a vanadium-molybdenum reagent and then analyzed with a UV spectrometer calibrated for reading the optical density at 420 nm, with demineralized water as a reference. This quantitative colorimetric analysis establishes a correlation between the optical density and the amount of P₂O₅ in solution so that the extraction solution can be measured. The final result is expressed as a percentage (mass of P₂O₅/mass of activated carbon×100%). It should be noted that in reality the method measures the phosphate chemical entity (PO₄³⁻), which is subsequently expressed as P₂O₅.

Extraction pH:

The activated carbon (10 g) is brought to reflux in tap water (150 ml) for 5 to 10 minutes. The mixture is filtered through a pleated filter. The filtrate is allowed to cool to room temperature. A calibrated pH measuring device is used to measure the pH of the filtrate and thus the extraction pH.

Electrical resistivity in ohm.cm:

The activated carbon powder is placed in the cylindrical body of an insulative mold. A piston applies a pressure to the powder thus compacted. A calibrated ohmmeter measures the electrical resistance (R in ohms) between the top and bottom of the compacted cylinder of activated carbon, which has cross section area of 2 cm².

The measurement is carried out at a force of 130 kg. A scale graduated in cm on the piston makes it possible to read off the height (H in cm) of the compacted cylinder of activated carbon.

The electrical resistivity in ohm.cm is given by the expression (R×2 cm²)/H.

BET surface area and pore distribution:

The data is obtained by isothermal argon adsorption measurement at 77° K carried out with a Micromeritics ASAP 2000 M instrument.

| | Measurement method | |
|---|---|---|
| | (Pica in-house or | |
| Characteristic | ASTM) | Value |
| CCl₄ adsorption in % | L22, No. 6 or | 60% to 120% |
| | ASTM D3467-94 | |
| Butane adsorption | L23, No. 3 or | 22% to 47% |
| in % | ASTM D5742-95 | |
| Iodine number | L26, No. 5 or | >900 |
| in mg/g | ASTM D4607-94 | |
| Extraction pH | L21, No. 7 | 1 to 2 |
| BET surface area | L17, No. 5 | >900 |
| in m²/g | | |
| Residual P₂O₅ in % | L34, No. 7 | 3% to 12% |
| Bulk density | L04, No. 6 or | 0.18 to 0.32 |
| in g/ml | ASTM D2854-93 | |
| Ball-pan hardness % | L07, No. 5 or | 50% to 65% |
| | ASTM D3802-94 | |
| Electrical | L14, No. 6 | >500 |
| resistivity in ohm.cm | | |

The ranges shown, in particular for the activity characteristics, represent, first, the variation in the parameters of the process and, secondly, the variation in the product for the same process parameters (heterogeneity due to variations in the starting materials, activation conditions, etc.). This is conventional in any continuous or batchwise process for the industrial manufacture of activated carbon.

The operation of the biological contactor method has in some cases given rise to specific problems related to the nature of the impurities in the activated carbon employed. Thus, when a filter filled with “Picabiol®” is placed in water, a large part of the residual P₂O₅ is sometimes leached by the water. The water which emerges from the filter is then enriched in P₂O₅, or more specifically in the chemical entity PO₄³⁻, and is also acidified by the corresponding acid. The operator of a water treatment plant can in some cases have problems with discharging this water, depending on the local natural environment. The operator has to satisfy the prevailing local laws in terms of quality (P₂O₅ content less than 5 mg/l and pH greater than 6.5 for the laws prevailing in Europe). These values can only be achieved at the outlet of the filter after a large volume of water has passed through. The result of this is that these operating restrictions can lead to significant additional process costs due to the management of these large amounts of nonpotable water. This release of acid can limit the uses of “Picabiol®” in any type of filter used to purify a liquid or a solution.

Another consequence of the residual P₂O₅ may be the relatively rapid fixing of calcium ions. A portion of the P₂O₅ remains present on the carbon-containing surface when the filter is placed in water. These phosphorus-containing entities can then rapidly fix calcium ions in the water to be treated by chemical affinity. This can initiate mechanisms that precipitate calcium carbonate and lead to premature aging of the activated carbon by blocking a portion of the porous structure. By withdrawing samples during the operation of a “Picabiol®” filter, calcium contents on the activated carbon of the order of 20 000 ppm, 30 000 ppm and 35 000 ppm have been observed for a lifetime of two months, three months and six months, respectively. These contents are high enough to pollute the activity of the activated carbon. Furthermore, the calcium precipitated on the surface of the activated carbon can cause problems during thermal regeneration of the spent activated carbon. The calcium has the effect of modifying the porosity of the activated carbon during the thermal regeneration treatment (see: The Effect of Metals on Thermal Regeneration of Granular Activated Carbon, AWWA Research Foundation Review, 1994).

It is an object of the invention to overcome these disadvantages, whilst retaining the existing performance of an activated carbon such as “Picabiol®”, by providing an activated carbon whose porosity allows highly satisfactory operation, both in biological mode and in adsorption mode, and whose chemical purity allows improved use in water treatment (in particular with minimum phosphorus impurities and acidity).

The invention is also aimed at a process for the manufacture of the activated carbon and at its application to water treatment, in particular for removing certain pollutants.

### SUMMARY OF THE INVENTION

To this end, the invention provides an activated carbon having the following characteristics:

CCl₄ number from 120% to 190%,

P₂O₅ content at most equal to 2%,

extraction pH greater than 7,

bulk density from 0.18 g/ml to 0.32 g/ml, and

electrical resistivity less than 1.5 ohm.cm.

The activated carbon thus combines in particular a high adsorption capacity, a low amount of P₂O₅ and a neutral or basic pH.

According to preferred and optionally combined features of the invention:

the activated carbon has a BET surface area of at least 2 000 m²/g, or even 1 800 m²/g, and/or an iodine number of at least 1 750 mg/g and/or a butane adsorption coefficient of 45% to 75%; it should be noted that these values reflect its adsorption capacity.

the activated carbon has a ball-pan hardness of at least 65%; this is because the criteria for choosing an activated carbon can incorporate mechanical characteristics.

it is obtained in granular or powder form (particle size distribution in which the particle size is typically between 0,15 mm and 4,75 mm), which makes it very particularly suitable for numerous uses in water treatment.

it has a micropore volume of at least 0.50 ml/g and a mesopore volume of at least 0.30 ml/g, which helps to guarantee a high adsorption capacity.

The invention additionally provides a process for preparing the above activated carbon, that is to say a process for the manufacture of an activated carbon comprising the following stages:

preparation of a precursor activated carbon by chemical activation of a starting material with phosphoric acid,

neutralization of this precursor with an aqueous solution, and

thermal activation.

The effects induced by the preparation of the precursor activated carbon are therefore neutralized whilst retaining the advantages thereof.

According to preferred and optionally combined features of the invention:

the precursor is obtained by chemical activation of wood with phosphoric acid, which corresponds in particular to the use of “Picabiol®”;

the precursor has the following characteristics:

CCl₄ number from 60% to 120%,

P₂O₅ content from 3% to 12%,

extraction pH from 1 to 2,

bulk density from 0.18 g/ml to 0.32 g/ml, and

electrical resistivity greater than 500 ohm.cm;

the above characteristics are those which are improved by the invention; the precursor preferably also has the following characteristics:

butane adsorption coefficient 22% to 47%,

iodine number at least 900 mg/g,

BET surface area at least 900 m²/g,

ball-pan hardness from 50% to 65%; it should be noted that the combination of these characteristics corresponds to those which define a “Picabiol®” activated carbon;

the neutralization stage is carried out with urea or ammonia, because these bases prove to be both effective and moderately priced;

during the neutralization stage, the base/precursor ratio is advantageously from 0.1 to 0.3, which corresponds to an excess of base with respect to what is strictly necessary to neutralize the residual phosphoric acid;

the water/precursor ratio is preferably from 1.5 to 2.5, which in practice gives the product a moist appearance, allowing good diffusion of the reactants into the porous structure of the carbon-containing material;

drying may be carried out in the neutralization stage, in order to reduce the water content of the product to less than 10%, if appropriate;

the activation stage is carried out at a reaction temperature from 800° C. to 1 000° C., which represents a good compromise;

the activation stage is carried out in a furnace in the presence of steam and/or carbon dioxide;

the precursor may in practice have a particle size greater than the ASTM No. 70 sieve (212 microns); after activation, there is then advantageously a particle size grading stage.

The invention further provides several applications of the above activated carbon, in particular the use of the activated carbon to treat water comprising organic matter, to remove atrazine, and to remove chloramines.

Objects, features and advantages of the invention will emerge from the description which follows, which is given by way of non-limiting example and with reference to the appended drawings.

### BRIEF DESCRIPTION OF THE DRAWINGS

FIG. 1 is a flowchart of a process for the manufacture of an activated carbon in accordance with the invention.

FIG. 2 is a graph correlating the equilibrium atrazine concentration (micrograms per liter) with the atrazine adsorption capacity (micrograms per milligram) for three activated carbons, including that of the invention.

FIG. 3 is a graph correlating the activated carbon charge (in mg/l) with the reduction in optical density (in %) for the same three activated carbons.

FIG. 4 is a graph showing the reduction in chloramines (in %) for the same three activated carbons.

### DETAILED DESCRIPTION OF THE PREFERRED EMBODIMENTS

The process of the invention can be understood as the addition of a specific treatment to an existing process involving a chemical activation with phosphoric acid, such as the process for the manufacture of “Picabiol®” activated carbon. It should be borne in mind that “Picabiol®” activated carbon is manufactured industrially by chemical activation of wood granules with phosphoric acid at a temperature from 400° C. to 500° C. The particle size of the granular precursor is preferably greater than the mesh size of the ASTM No. 70 sieve (212 μm). This size is used arbitrarily here to distinguish the concept of a granular material (particle sizes above this threshold) from the concept of a powder material (particle sizes below this threshold).

According to the invention, the precursor is then treated as follows:

Stage 1: Neutralization:

The precursor activated carbon is brought into contact with an aqueous solution of a base in order to neutralize the acidity of the activated carbon. The base used is advantageously urea or ammonia, dissolved in water at room temperature. The “base/precursor” ratio by weight is preferably from 0.1 to 0.3; it corresponds to an excess stoichiometry of the reaction for neutralization of the residual phosphoric acid by the base.

The amounts of basic solution are advantageously adjusted to obtain an activated carbon with a moist appearance, which corresponds in practice to a “water/precursor” ratio by weight from 1.5 to 2.5. This allows good diffusion of the reactants into the porous structure of the carbon-containing material.

Industrially, this treatment can be carried out batchwise or continuously.

If necessary, neutralization is followed by drying to reduce the water content of the product to less than 10%.

Stage 2: Thermal Activation:

The neutralized activated carbon is subsequently introduced into an activation furnace operating under “physical” or “thermal” conditions. The furnace can be a continuous rotary tube furnace or a fluidized bed furnace.

The main physical activation conditions are:

Reaction temperature from 800° C. to 1 000° C.

Activating gas introduced into the furnace: steam or carbon dioxide.

Heating mode: direct or indirect.

In carrying out this activation process, the activation time, i.e. the treatment time, fixes the characteristics of the finished product for a given temperature. The treatment time cannot be precisely defined for a continuous system, as it depends on the technology employed and the geometric characteristics of the furnace. The degree of activation related to the activation time can also be specified by expressing the yield by weight obtained: the longer the activation time, the higher the activity obtained and consequently the lower the yield by weight, because of the consumption of carbon. Finally, the final activity of the product is also conditioned by the level of activity of the precursor.

The characteristics of the product neutralized and activated by this process are then as follows:

| | Measurement method | |
|---|---|---|
| | (inn-house Pica or | |
| Characteristic | ASTM) | Value |
| CCl₄ adsorption in % | L22, No. 6 or | 120% to 190% |
| | ASTM D3467-94 | |
| Butane adsorption | L23, No. 3 or | 45% to 75% |
| in % | ASTM D5742-95 | |
| Iodine number | L26, No. 5 or | >1750 |
| in mg/g | ASTM D4607-94 | |
| BET surface area | L17, No. S | >1800 |
| in m²/g | | |
| Bulk density | L04, No. 6 or | 0.18 to 0.32 |
| in g/ml | ASTM D2854-93 | |
| Extraction pH | L21, No. 7 | 7 to 11 |
| Residual P₂O₅ in % | L34, No. 7 | <2% |
| Ball-pan hardness in % | L07, No. 5 or | >65% |
| | ASTM D3802-94 | |
| Electrical resistivity | L14, No. 6 | <1.5 |
| in ohm.cm | | |

The ranges shown, in particular for the activity characteristics, originate, first, from the variation in the parameters of the process and, secondly, from the variation in the product for the same process parameters (heterogeneity due to variations in the starting materials, activation conditions, etc.). This is conventional for any continuous or batchwise process for the industrial manufacture of activated carbon.

The treatment applied has the effect:

of volatizing or subliming the phosphorus-containing entities of the activated carbon in the gas stream and proportionately reducing the acidity of the activated carbon. This is because the level of residual P₂O₅ is greatly reduced and the product is no longer acidic nature in water.

of structuring the carbon-containing backbone at high temperature and of rendering it mechanically stronger (hardness) and electrically more conductive (resistivity). This structuring is comparable to a carbonization stage, yielding a more “graphitized” material.

of creating additional porosity by a mechanism of controlled oxidation of the carbon and of proportionately increasing the adsorption capacity. The adsorption capacity corresponds to the pore volume, and is characterized by several related methods and characteristics, namely: the CCl₄ or butane capacity, the iodine number, and the BET surface area. Thus the threshold of 120% for the CCl₄ capacity corresponds substantially to the threshold of 45% for butane and to the thresholds of 1 750 mg/g for the iodine number and of 1 800 m²/g for the BET surface area.

The capacity obtained depends on the activation time and the initial activity of the starting material.

Stage 3: Particle Size Grading:

The product is then graded to the desired particle size by sieving, optionally in combination with the use of a unit for crushing the sieving oversize. This achieves the required particle size distribution for granular activated carbon. For powdered activated carbon, it is necessary to carry out milling or to recover the fine sieving fractions.

This process thus results in a novel and somewhat remarkable activated carbon whose properties analyzed above are not modified by particle size grading and which has the following advantages:

Low residual P₂O₅ level, leading neither to leaching nor to acidification in water.

Increased capacity, implying much more efficient operation in the adsorption mode.

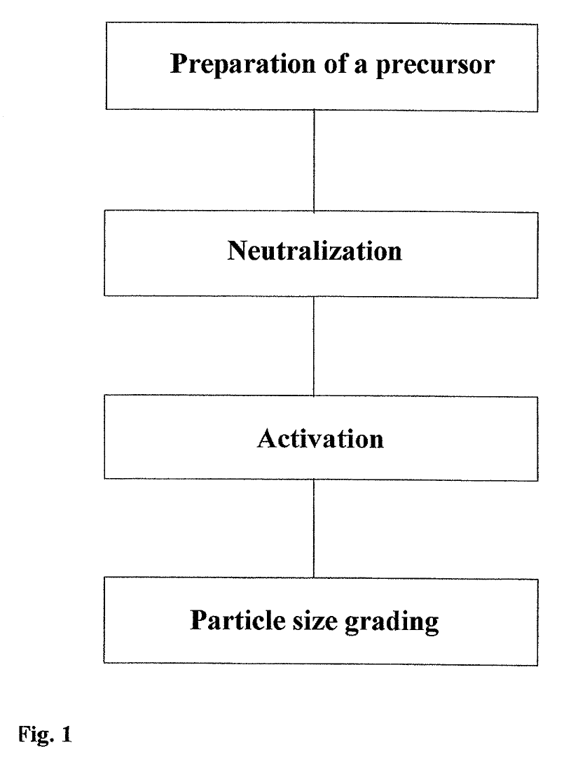

The entire manufacturing process as just described is represented schematically in FIG. 1.

Some manufacturing conditions and the characteristics of the corresponding products are specified in the following examples of implementation of the invention (the products according to the invention are denoted below under the reference GX 191 ER). The weights are based on dry solid material.

### EXAMPLE 1

a) Precursor selected (obtained by the process defined with reference to “Picabiol®”):

Particle size: 6×16 mesh

CCl₄ activity: 120%

pH: 1.9

Residual P₂O₅: 4%

b) Neutralization:

Urea/precursor ratio by weight: 0.25

Water/precursor ratio by weight: 2.2

Batch mixing with stirring for a few minutes

Drying at 110° C. in a rotary furnace

c) Activation:

Rotary activation furnace with continuous feeding of product to be activated

Precursor feed rate: 700 kg/h, on average

Temperature: 850° C. to 900° C.

Activating gas: steam at 300 kg/hour, on average

Amount treated: 1 150 kg

Yield by weight of heat treatment: 40%

d) Product obtained after sieving:

Particle size: 10×25 mesh

CCl₄ activity: 137%, which corresponds to a BET

surface area of 1 900 m²/g

Bulk density: 0.24 g/ml

pH: 8

Residual P₂O₅: 0.6%.

This example shows a significant change in the chemical purity of the product and an increase in activity.

### EXAMPLE 2

a) Precursor selected:

Particle size: 16×60 mesh

CCl₄ activity: 75%

pH: 1.5

Residual P₂O₅: 7.5%

b) Neutralization:

Urea/precursor ratio by weight: 0.18

Water/precursor ratio by weight: 2

Batch mixing with stirring for a few minutes

Drying at 110° C. in a rotary furnace

c) Activation:

Rotary activation furnace with continuous feeding of product to be activated

Precursor feed rate: 220 kg/h to 240 kg/h

Temperature: from 820° C. to 880° C.

Activating gas: steam at 200 kg/h to 250 kg/h

Amount treated: 10 900 kg

Yield by weight of heat treatment: 34%

d) Product obtained after sieving:

Particle size: 40×100 mesh

CCl₄ activity: 148%, on average

Iodine number: 1 900 mg/g

Bulk density: 0.24 g/ml

pH: 8

Residual P₂O₅: 1%

Electrical resistivity: 0.6 ohm.cm.

This example shows a significant change in the chemical purity and adsorption capacity of the activated carbon. A significant porosity had been produced. The BET surface area of this product was 2 250 m²/g. The micropore and mesopore volumes were 0.77 ml/g and 0.45 ml/g, respectively. Finally, the median pore diameter was 15.4 Å.

### EXAMPLE 3

a) Precursor selected:

Particle size: 16×30 mesh

CCl₄ activity: 100%, on average

pH: 1.5

Residual P₂O₅: 3%

b) Neutralization: none

Urea/precursor ratio by weight: 0

Water/precursor ratio by weight: 0

c) Activation:

Rotary activation furnace with continuous feeding of product to be activated

Precursor feed rate: 160 kg/h, on average

Temperature: from 830° C. to 880° C.

Activating gas: steam at 290 kg/h, on average

Amount treated: 9 280 kg

Yield by weight of heat treatment: 33%

d) Product obtained at furnace outlet:

Particle size: passes 16 mesh

CCl₄ activity: 148%

Iodine number: 1 750 mg/g

Bulk density: 0.2 g/ml

pH: 3.7

Residual P₂O₅: 2%

Electrical resistivity: 0.4 ohm.cm.

This example clearly shows that, without the neutralization stage, the product displayed an increased pH after heat treatment, but not a sufficient increase to be close to neutrality. An increase in activity was nevertheless obtained.

None of the above manufacturing examples or examples of products obtained is limiting on the process or its parameters.

The operation in adsorption mode of the product GX 191 ER was validated experimentally by tests in an aqueous medium (see Examples 4, 5 and 6 below):

### EXAMPLE 4

### Atrazine Adsorption Capacity

Atrazine is a herbicide found in water.

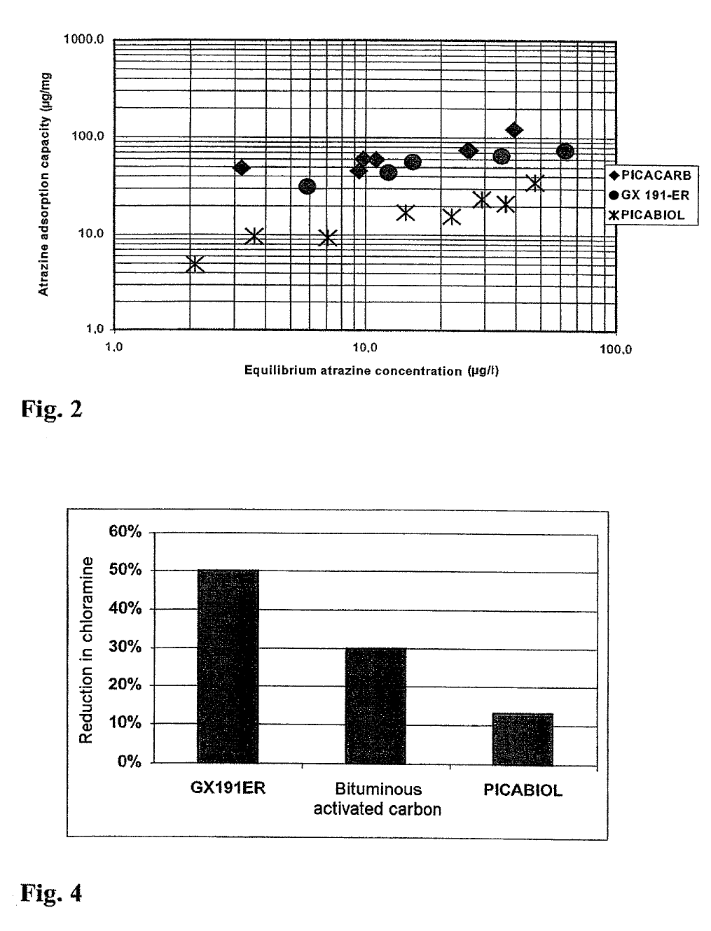

Room-temperature adsorption isotherms were produced by bringing different masses of powdered activated carbon into contact with a fixed volume of a reconstituted aqueous solution (demineralized water) containing 100 μg/l of atrazine. After a contact time of five days with stirring and exclusion of light, the water was filtered through a pleated filter and then the atrazine was then measured with an HPLC device and a UV detector from Waters. The results were subsequently expressed graphically in the conventional Freundlich form on a log/log scale, with the atrazine adsorption capacity per unit mass of activated carbon (in μg/mg) as a function of the equilibrium atrazine concentration (in μg/l). The above conditions and this form of graph (see FIG. 2) enable the effectiveness of various activated carbons at equilibrium to be compared.

The result was that the product GX 191 ER, manufactured as in Example 1, was as effective as a Picacarb activated carbon with an inorganic base and more effective than a “Picabiol®” activated carbon. The difference in capacity for the same equilibrium concentration was greater by a factor of at least 3.

This effectiveness, demonstrated for a herbicide known in the water treatment art, can be generalized to encompass other pesticides or polluting organic entities with a similar molecular size.

### EXAMPLE 5

### Adsorption Capacity for Organic Matter from River Water

The test consisted in bringing a fixed volume of a river water (Le Cher—France) into contact with various quantities of powdered activated carbon at 25° C. for 2 hours, with stirring, and measuring the reduction in organic matter in the water after filtration. The concentration of organic matter was measured by UV spectrometry and expressed in terms of optical density at a wavelength of 254 nm. This wavelength is characteristic of the chemical bonds between carbon and oxygen atoms.

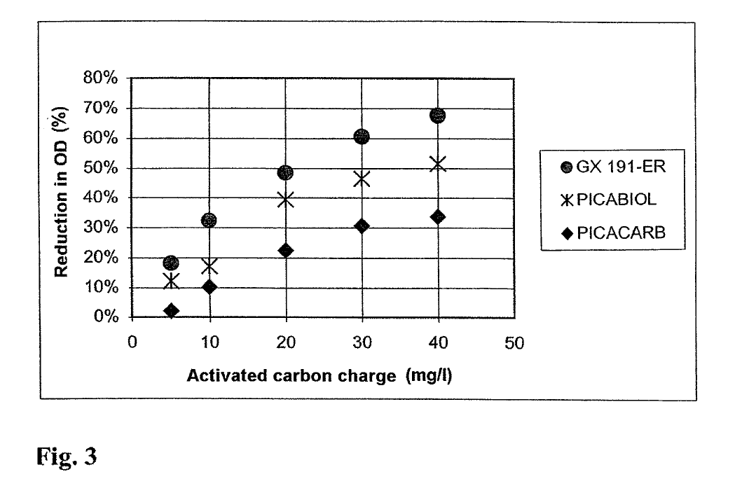

The results are represented by a graph expressing the reduction in optical density as a function of the concentration of activated carbon in the water: (initial OD−OD)/initial OD (see FIG. 3).

The organic matter consisted of compounds with fairly high molecular weights and therefore large sizes. To adsorb these compounds, the porous structure has to facilitate access to them. Note that the amount and quality of organic matter are specific to the water sampled and therefore influence the results. A Picacarb activated carbon with relatively closed pores had a poorer performance than Picabiol and GX 191 ER activated carbons with more open pores. GX 191 ER activated carbon, manufactured as in Example 1, was also distinguished by its higher overall activity, and therefore a higher capacity.

### EXAMPLE 6

### Monochloramine (NH₂Cl) Adsorption Capacity

Monochloramine is a pollutant present in water produced by chlorination treatment in the presence of ammonia.

The capacities were measured starting from a reconstituted aqueous solution (demineralized water) containing 3 mg/l of monochloramine (NH₂Cl). The monochloramine was prepared in water by reacting sufficient amounts of ammonium chloride NH₄Cl and sodium hypochlorite NaClO. The pH was adjusted to a value above 11 by adding concentrated sodium hydroxide solution. The method used to measure the chloramines in the water was that of French Standard NF T 90-038, i.e. a colorimetric method using the reagent DPD to measure the combined chlorine (corresponding to monochloramine if the pH is greater than 6), which represents the difference between total chlorine and free chlorine.

The test consisted in subsequently introducing a fixed amount (250 mg) of powdered activated carbon reduced into a fixed volume (1 000 ml) of the reconstituted water while stirring with a bar magnet and then, after a defined contact time (1 minute), rapidly filtering the solution through a pleated filter with a water vacuum pump. The filtration time was set from 10 to 15 seconds, in order to recover 250 ml of filtrate. The filtrate was finally measured for monochloramine in order to determine the reduction in concentration: (initial C−C)/initial C (see FIG. 4).

GX 191 ER activated carbon, manufactured as in Example 1, halved the concentration of NH₂Cl in the water. The fairly short contact time showed that the adsorption kinetics were fast, promoted by an open porous structure allowing good access to the pollutant. The high capacity also allows high adsorption.

All these examples therefore illustrate the very good adsorption capacity of the activated carbon according to the invention with respect to pollutants in water to be treated. Its effectiveness is directly related to the high porosity developed by the product.

The above experimental conditions and types of pollutants to be adsorbed are not limiting on the invention.

### EXAMPLE 7

Finally, another use of the product GX 191 ER is to incorporate it in any “double-layer” electrode system for a so-called “electrical supercapacitor”. A supercapacitor stores and rapidly delivers an electrical current. Its advantage over a conventional battery, for example, is that it can deliver high powers over a large number of charging/discharging cycles.

The activated carbon is a component of the electrode and traps ions of an aqueous or organic electrolyte to store a corresponding amount of current; the adsorption of these ions is promoted by an electrical potential at the terminals of two electrodes (charging). This amount of current can be reversibly restored to produce current (discharging). The low electrical resistivity of GX 191 ER also facilitates flow of the electrical charges. Supercapacitors can therefore supply high electrical powers. The invention does not relate to this application, which consequently is not described in detail. In simple terms, the invention provides a product possessing essential characteristics that are necessary for this application: high adsorption capacity, a porosity suitable for adsorption of ions, and relatively good electrical conductivity.

There is claimed:

1. Activated carbon having the following characteristics:
CCl₄ number from 120% to 190%,
P₂O₅ content at most equal to 2%,
extraction pH greater than 7,
bulk density from 0.18 g/ml to 0.32 g/ml, and
electrical resistivity less than 1.5 ohm.cm.

2. The activated carbon claimed in claim 1 when it has a BET surface area of at least 2 000 m²/g.

3. The activated carbon claimed in claim 1 when it has a BET surface area of at least 1 800 m²/g.

4. The activated carbon claimed in claim 1 when it has an iodine number of at least 1 750 mg/g.

5. The activated carbon claimed in claim 1 when it has a butane adsorption coefficient of 45% to 75%.

6. The activated carbon claimed in claim 1 when it has a ball-pan hardness of at least 65%.

7. The activated carbon claimed in claim 1 when it has a particle size distribution in which the particle size is less than 4.75 mm and greater than 0.15 mm.

8. The activated carbon claimed in claim 1 when it is a powder with a particle size less than 212 microns.

9. The activated carbon claimed in claim 1 when it has a micropore volume of at least 0.50 ml/g and a mesopore volume of at least 0.30 ml/g.

10. A process for manufacturing an activated carbon, said process comprising the following stages:
preparing a precursor activated carbon by chemically activating a starting material with phosphoric acid,
neutralizing said precursor with an aqueous solution, and
thermal activation.

11. The process claimed in claim 10 wherein said precursor is obtained by chemically activating wood with phosphoric acid.

12. The process claimed in claim 10 wherein said precursor has the following characteristics:
CCl₄ number from 60% to 120%,
P₂O₅ content from 3% to 12%,
extraction pH from 1 to 2,
bulk density from 0.18 g/ml to 0.32 g/ml, and
electrical resistivity greater than 500 ohm.cm.

13. The process claimed in claim 12 wherein said precursor additionally has the following characteristics:
butane adsorption coefficient 22% to 47%,
iodine number at least 900 mg/g,
BET surface area at least 900 m²/g, and
ball-pan hardness from 50% to 65%.

14. The process claimed in claim 10 wherein said neutralization is carried out with urea or ammonia.

15. The process claimed in claim 10 wherein the base/precursor ratio is from 0.1 to 0.3.

16. The process claimed in claim 10 wherein the water/precursor ratio is from 1.5 to 2.5.

17. The process claimed in claim 10 wherein said neutralization includes drying in order to reduce the water content of said product to less than 10%.

18. The process claimed in claim 10 wherein said activation is carried out at a reaction temperature from 800° C. to 1 000° C.

19. The process claimed in claim 10 wherein said activation is carried out in a furnace in the presence of steam and/or carbon dioxide.

20. The process claimed in claim 10 wherein said precursor has a particle size greater than the ASTM No. 70 sieve (212 microns) and further including a particle size grading stage.

21. Use of activated carbon as claimed in any of claims 1 to 9 for the treatment of water containing organic matter.

22. Use of activated carbon as claimed in any of claims 1 to 9 to remove atrazine.

23. Use of activated carbon as claimed in any of claims 1 to 9 to remove chloramines.
